(19) United States
(12) Patent Application Publication
(10) Pub. No.: US 2002/0019773 A1
(43) Pub. Date: Feb. 14, 2002

(54) Point managing method

(76) Inventor: Seiji Shibahara, Tokyo (JP)

Correspondence Address: Thomas R. Morrison, Esq., MORRISON LAW FIRM, 145 North Fifth Avenue, Mount Vernon, NY, 10550, US

(21) Appl. No.: 09/903,957

(22) Filed: Jul. 12, 2001

(30) Foreign Application Priority Data
Jul. 13, 2000 (JP) 2000-212891

(51) Int. Cl. G06F 17/60

(52) U.S. Cl. 705/14

(57) ABSTRACT

A point managing method, wherein, regardless of the number of points provided by each service offerer, consumers' incentive for browsing webpages may be increased. Each service offerer can independently offer their services using points provided by themselves. The obtained points of each consumer are managed for each service offerer. When consumers exchange points for a value, the consumers select points to be used for exchanging for the value for each service offerer. Points of the selected service offerers are summed up under an appointed exchange rate and are exchanged for goods which is corresponds to the number of the summed points. In this way, besides the joint exchange for goods by the agent, each service offerer can independently offer their services using points provided by themselves, for example, each service offerer can seaparately carry out exchange for goods using points provided by themselves.

### BACKGROUND OF THE INVENTION

1. Field of the Invention

The present invention relates to a point managing method using a computer for managing points. The points are provided to consumers by each service offerer when the consumers use services offered by each service offerer. The points are exchangable for a fixed value.

2. Description of the Prior Art

To increase the effect of information transmission using the Internet, for example, some systems have already come into practical use wherein consumers are provided points by browsing webpages. These points can be exchanged for the corresponding value (such as goods) when the points are accumulated to a certain extent.

As an example of such systems, Japanese Patent Publication No. 11-3372 discloses point managing system, wherein a plurality of service offerers (advertisement offerers) are affiliated with a point managing organization, in a server of which, points provided to consumers by browsing webpage of each service offerer, are accumulated all together for each consumer. By using this kind of point managing system, consumers can obtain points by browsing webpages offered by any service offerer who is affiliated with the point managing organization. Whereby, even if consumers are not provided enough points by a single service offerer, the consumers can obtain enough points to exchange for a value, by summing up points of a plurality of service offerer. In this way, consumers' incentive for browsing webpages is increased.

However, in the above-mentioned conventional point managing system, the point managing organization provided points common to all service offerers, and the points provided to the consumers were not accumulated for each service offerer. Therefore, service offerers could not make consumers to exchange for a value using only points provided by themselves. That is, service offerers could not emphasize their own identity in exchanging points for a value.

### OBJECTS AND SUMMARY OF THE INVENTION

It is an object of the present invention to provide a point managing method and system which overcomes the foregoing problems.

It is a further object of the present invention to provide a point managing method and system wherein points are accumulated for each service offerer, and the efforts of specific service offerers to improve their service are linked with the increase of points, thereby increasing consumers' incentive for browsing webpages.

The present invention provides a point managing method using a computer for managing points, which are provided to consumers by each service offerer when the consumers use services offered by each service offerer. The points are exchangable for a fixed value. The point managing method includes the steps of storing the number of accumulated points of each service offerer in a point storing means for each consumer, and displaying the number of the accumulated points of a consumer for each service offerer as a list, which is stored in the point storing means. Each service offerer's identity is emphasized and service offerers' efforts to increase their sales can succeed.

The point managing method according to the present invention further includes a step of displaying an exchanging point input page on which the consumer can select service offerers whose points are to be exchanged for the value. By means of such composition, the consumer can select service offerers whose points are to be exchanged for a value depending on the consumer's preference.

Still further, the point managing method according to the present invention further comprises the steps of summing up the accumulated points of each selected service offerer regarding the consumer under the appointed rate, after service offerers are selected as mentioned above, and in accordance with the summed points, a process of exchanging points for the value may be conducted, and subtracting points of each selected service offerers regarding the consumer, which were used for exchanging for the value, from the point storing means, using a computer.

By means of such a composition, consumers will buy goods and browse advertisements regarding service offerers whose exchange rates are high, whereby, the efforts of service offerers who keep their exchange rates high will succeed.

Furthermore, consumers may select a part of points provided by service offerers when the consumers select service offerers whose points are to be exchanged for the value. In this case, consumers can avoid a waste of the points, thus, this way of selecting points can increase consumers' convenience.

The above, and other objects, features, and advantages of the present invention will become apparent from the following description read in conjunction with the accompanying drawings, in which like reference numerals designate the same elements.

### BRIEF DESCRIPTION OF THE DRAWINGS

FIG. 1 is a flow chart explaining a process of providing consumers with points in a point managing system according to one embodiment of the present invention.

FIG. 2 is a figure illustrating an example of a construction of connection of computers used for carrying out a point managing method according to one embodiment of the present invention.

FIG. 3 is a figure illustrating an example of a simple construction of said computers.

FIG. 4 is a figure illustrating an example of display screen of a mail client.

FIG. 5 is an example of display screen of a web browser, explaining an operation of inputting a user ID.

FIG. 6 is the other example of a display screen of a web browser, illustrating an appearance of displaying the number of the obtained points.

FIG. 7 is a flow chart explaining a process of exchanging points in a point managing system according to one embodiment of the present invention.

FIG. 8 is an example of the stored data in an owner managing DB 1023.

FIG. 9 is an example of the stored data in a linked URL address managing DB 1024.

FIG. 10 is an example of the stored data in an user point managing DB 1025.

FIG. 11 is an example of a display screen of a web browser, illustrating an appearance of displaying the number of the obtained points of a consumer for each advertisement offerer and a list of goods for exchange.

FIG. 12 is a flow chart illustrating an example of a point displaying process in the case of managing points among a plurality of point managing organization.

### DETAILED DESCRIPTION OF THE INVENTION

In the following detailed description numerous specific details are set forth in order to provide a thorough understanding of the present invention. However, it will be understood by those skilled in the art that the present invention may be practiced without these specific details. In other instances, well known methods, procedures, components, and circuits have not been described in detail so as not to obscure the present invention.

A point managing method according to one embodiment of the present invention is improved from such conventional point managing methods wherein a plurality of service offerers are affiliated with one point managing organization (agent) which mediates the management of points, in a server of which points provided to consumers by each service offerer are accumulated all together for each consumer. In the point managing method according to one embodiment of the present invention, consumers can sum up points for each service offerer and exchange the summed points for such as goods. Furthermore, although many kind of services can be thought as a service which offered to consumers by service offerers in exchange for providing points to consumers, herein, it is assumed that service offerers offers advertisements on their webpages for consumers, and the service offerers provide appointed points to the consumers who browse their webpages.

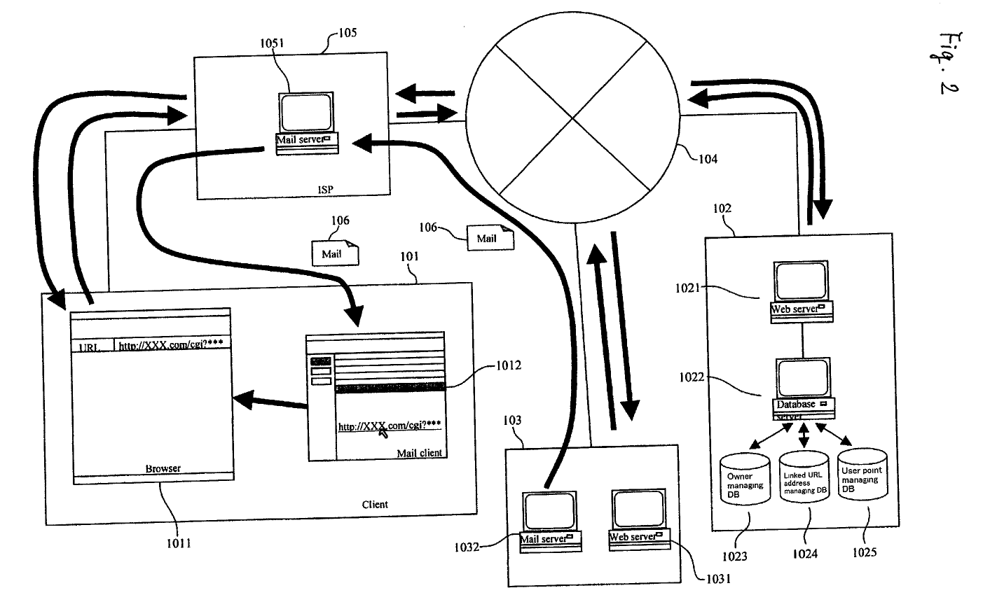

In the system where the point managing method according to one embodiment of the present invention is practicable, as shown in FIG. 2, a computer or a computer group 101 used by a consumer, a computer or a computer group 102 used by an agent and a computer or a computer group 103 used by an advertisement offerer (one example of a service offerer) are connected with each other via an Internet 104. The consumer communicates via Internet, for example, by dial-up connecting to a computer group 105 of an ISP (Internet Service Provider).

The computer group 102 of the agent, the computer group 103 of the advertisement offerer and the computer group 105 of the ISP include computers, each of which operates as a web server, a mail server (POP server, SMTP server, etc.), a DNS (Domain Name System) server, etc.

Among these servers, FIG. 2 shows a web server 1021 of the agent, a web server 1031 of the advertisement offerer, a mail server 1032 of the advertisement offerer and a mail server 1051 of the ISP. Furthermore, in the computer group 102 of the agent, a computer which operates as a database server (hereinafter simply called a database server) is included, in addition to the above mentioned servers.

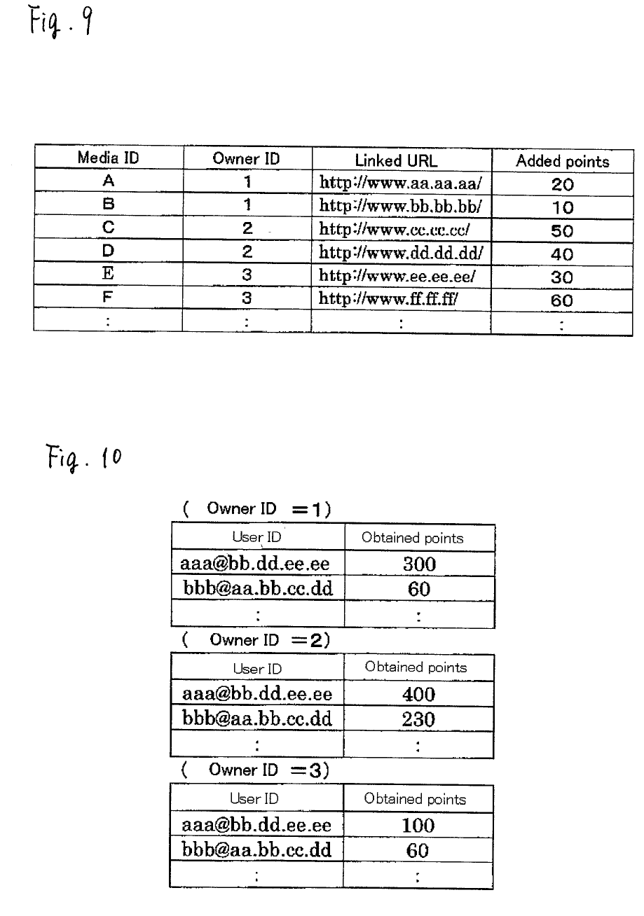

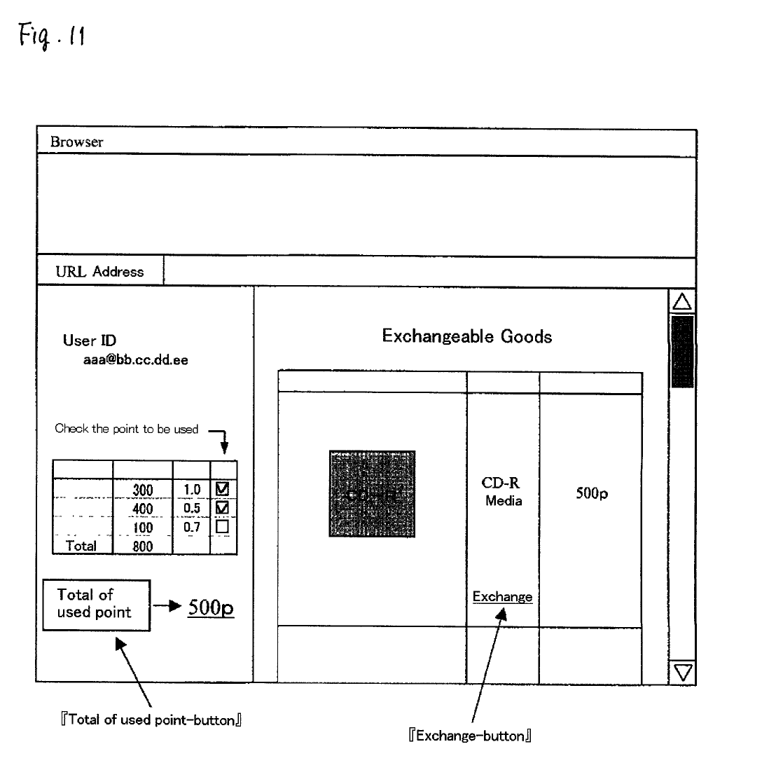

The database 1022 is connected with a database 1023, a database 1024 and a database 1025. The database 1023 is a owner managing DB, in which an exchange rate is memorized for each owner ID to identify the advertisement offerers, by which points provided by different advertisement offerers are summed up at the agent. (See FIG. 8). The database 1024 is a linked URL address managing DB, in which an owner ID, an URL (Uniform Resource Locator) address of Webpage and the number of the added points which are added by browsing the webpage are memorized for each media ID, one or more media IDs are granted for each owner ID (See FIG. 9). Furthermore, the database 1025 is a user point managing DB, in which the number of the obtained points of each advertisement offerer (owner ID) up to now is memorized corresponding to user IDs to identify consumers (See FIG. 10).

Furthermore, in the point managing method according to one embodiment of the present invention, points provided by each advertisement offerer are basically independent points for each advertisement offerer, so it is assumed that advertisement offerers can utilize the points provided by themselves separately. For example, the advertisement offerers separately exchange the points for goods. Therefore, it is possible to separately set the added points for each advertisement offerer. In such reasons, the exchanging rates are set in order to set the rate gap at the time of summing up the independent points of each advertisement offerer.

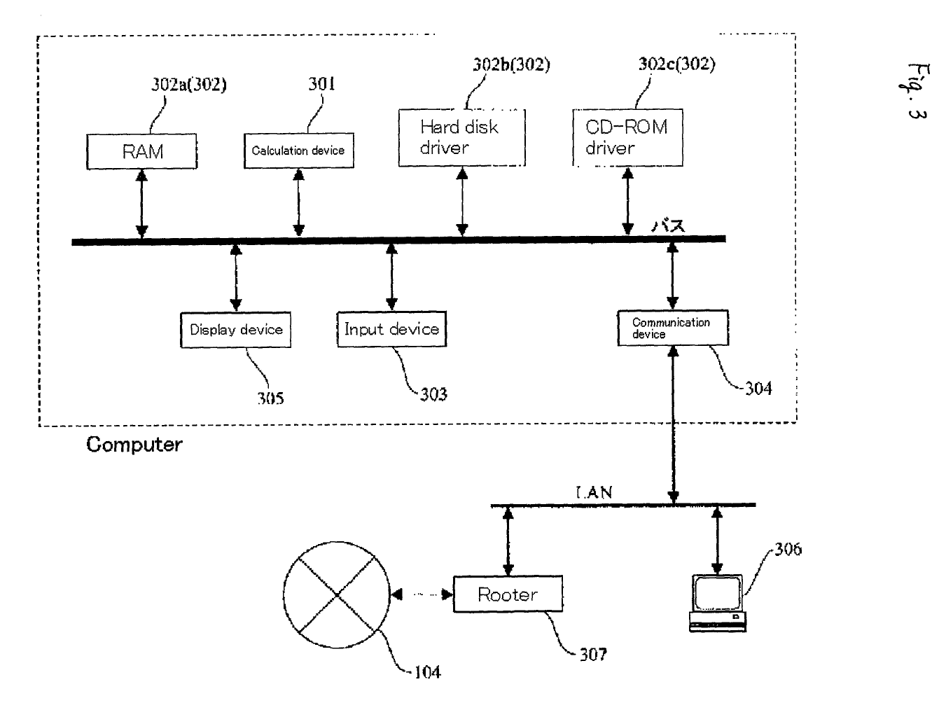

There are various kind of constructions of computer included in the computer group 102 of the agent, the computer group 103 of the advertisement offerer and the computer group 105 of the ISP depending on each scale. However, as shown in FIG. 3, such a computer fundamentally includes a calculation device 301, a memory device 302 including a memory 302a, a hard disk driver 302b and a CD-ROM driver 302c and the other memory devices, a input device 303, a communications device 304. Furthermore, such a computer as included in the computer group 102, 103, 105 also includes a display device 305 according to need and is connected with a router 309 which is connected with the other computer 306 and a Internet 104 via LAN.

As shown in FIG. 3, the computer 101 of the consumer can be constructed as such a computer, wherein a web browser (HTTP client) 1011 and a mail client 1021 are operable. A representative of those computers is a personal computer. However, it is also possible to utilize game players, portable terminals including cell phone, household electrical goods, all which have constructions equivalent to the construction as shown in FIG. 3.

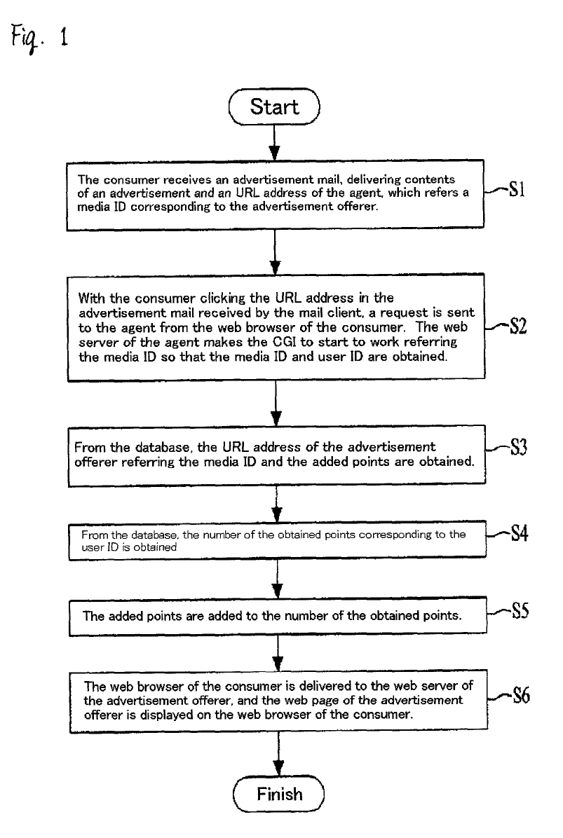

Hereinafter, referring to the flow chart shown in FIG. 1, a description is given of the procedure of providing points to consumers. Herein, it is assumed that a mail address is used as a User ID of each consumer.

Firstly, an advertisement mail 106 is sent to a mail server 1051 of the ISP used by consumers. The advertisement mail 106 delivers contents of an advertisement for goods and services and an URL address for a web server 1021 of the agent, which designates a CGI (Common Gateway Interface) referring a media ID corresponding to the advertisement offerer. (Procedure S1). Herein, the CGI is a program described by a program language such as a Perl, for example, which is stored in a storage device 302 of the web server 1021 in an operatable condition, and starts to work in response to a request from the web server. The advertisement mail 106 which are received by the mail server 1051 are stored in a spool file for the meantime.

As a request of receiving a e-mail is sent to the mail server 1051 of the ISP from the mail client 1012, which started to work on the computer 101 used by the consumer, the mail server 1051 obtains an e-mail addressed to the consumer from the spool file, and the e-mail addressed to the consumer which includes the advertisement mail 106 is sent to the mail client 1012.

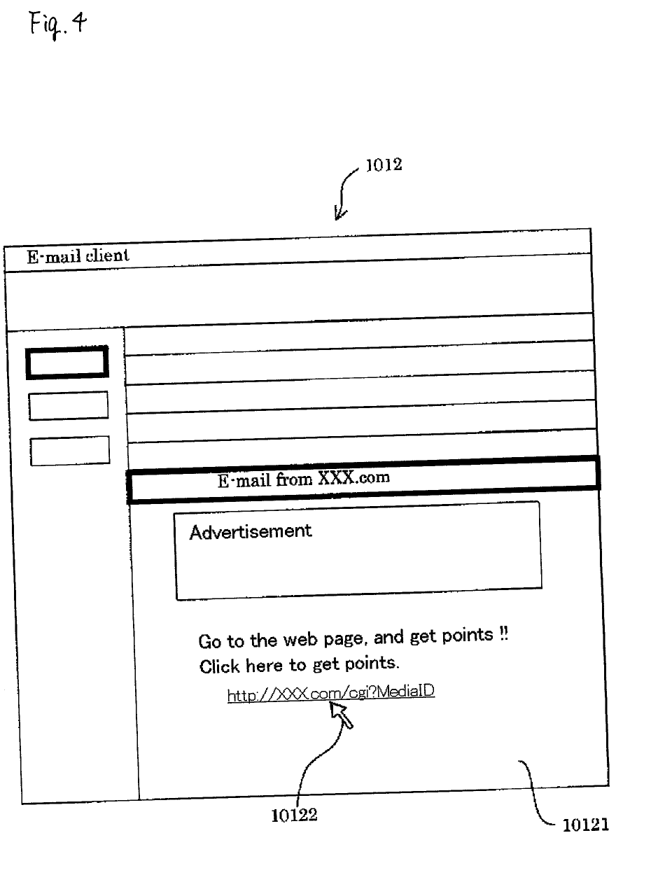

As shown in FIG. 4, the contents of the received e-mail can be confirmed, for example, on a preview pain 10121 on the mail client.

As shown in FIG. 4, on the advertisement mail, the URL address for the web server 1021 of the agent, such as http://XXX.com/cgi?mediaID, is described with the contents of the advertisement.

When the consumer selects the concerned URL address which is in a clickable condition on the mail client 1012, for example, by setting a pointer 10122 on the URL address and clicking, the web browser 1011 starts to work on the computer 101 of the consumer, by which a request is sent to the web server 1021 of the agent, which is designated by the URL address.

If the web browser 1011 of the consumer have been connected with the web server 1021 of the agent before, a cookie (HTTP cookie) (in which an user ID is included) stored in an appointed file on the storage device 302 of the computer 101 of the consumer is added to the request.

The request sent from the web browser 1011 of the consumer is received by the web server 1021 of the agent. The web server 1021, which recognize that the CGI is designated referring the media ID on the received URL address, makes the CGI to start to work.

The media ID and the user ID included in the request are input into a standard input of the web server 1021 of the agent. An ID information of the consumer and an ID information of the advertisement offerer are obtained. (Procedure S2).

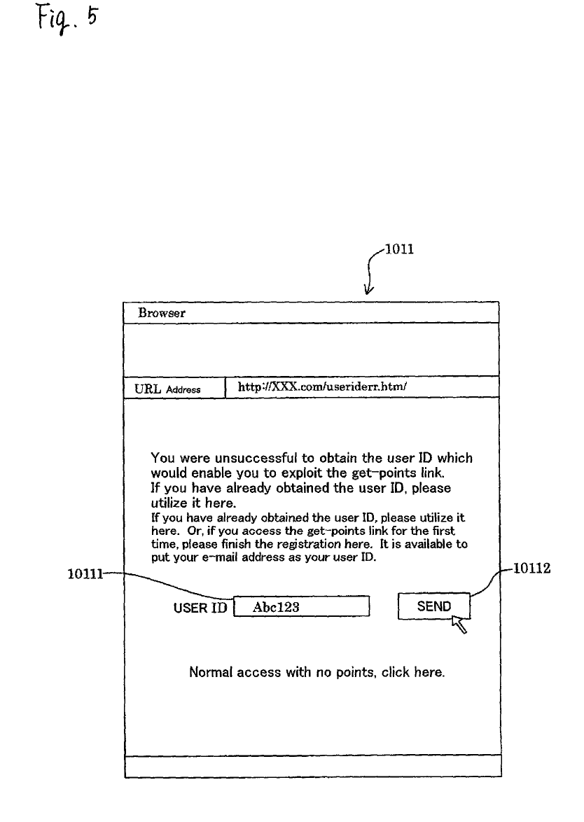

In the case where the user ID cannot be obtained in the web server 1021 of the agent normally, for the reason that the web browser of the consumer is connected with the web server 1021 of the agent for the first time, or the cookie is destroyed, such a webpage as shown in FIG. 5 is sent to the web browser 1011 of the consumer and displayed on the web browser 1011 in order to encourage to input the user ID or to register the user ID.

When the consumer inputs the user ID into a text input object 10111 and clicks a sending button object 10112, the web browser 1011 of the consumer sends the user ID to the web server 1021 of the agent. Then, the web server 1021 inputs the user ID into the standard input and makes the CGI to start to work.

The CGI, which started to work, sends a request for search to a database server 1022 by using the communications device 304 in order to search for the user ID existing in the standard input. As the database server 1022 receives the request for search from the CGI, the database server 1022 searches a user point managing DB 1025 for the concerned user ID. FIG. 10 shows one example of the data stored in the user point managing DB 1025. In the case where the concerned user ID is registered in the user point managing DB, the number of the obtained points which are obtained up to now by the consumer from the advertisement offerer (owner ID) corresponding to the media ID, which is stored in the user point managing DB 1025 corresponding to the concerned user ID, is returned to the CGI as a result of the search. On the other hand, in the case where the user ID is not registered in the user point managing DB 1025, the result of the search indicating that the number of the obtained points obtained by the consumer up to now is zero is returned to the CGI.

Processes of searching for the media ID and for the user ID which is obtained normally are almost same as the above described process of searching for the user ID which is not obtained normally.

Regarding the media ID and the user ID which is obtained normally, as well, the CGI, which started to work, sends a request for a search to a database server 1022 by using the communications device 304 in order to search for the media ID and the user ID which are input in the standard input of the web server 1021. As the database server 1022 receives the request for search from the CGI, the database server 1022 searches the linked URL address managing DB 1024 and the user point managing DB 1025 for the concerned media ID and the concerned user ID respectively. FIG. 9 shows one example of the data stored in the linked URL address managing DB 1024. An URL address and the number of the added points corresponding to the media ID searched from the linked URL address managing DB 1024 and the number of the obtained points obtained up to now by the consumers from the advertisement offerer (owner ID) corresponding to the user ID searched from the user point managing DB 1025 are returned to the CGI (Procedure S3, S4).

As the number of the added points for the media ID and the number of the obtained points for the user ID are obtained, the CGI adds the number of the added points to the number of the obtained points (Procedure S5), and the number of the obtained points in the user point managing DB 1025 is renewed. Further, a webpage including the renewed number of the obtained points and the URL address of the advertisement offerer is made by the CGI, the webpage is delivered to the web server 1021 of the agent through the standard output.

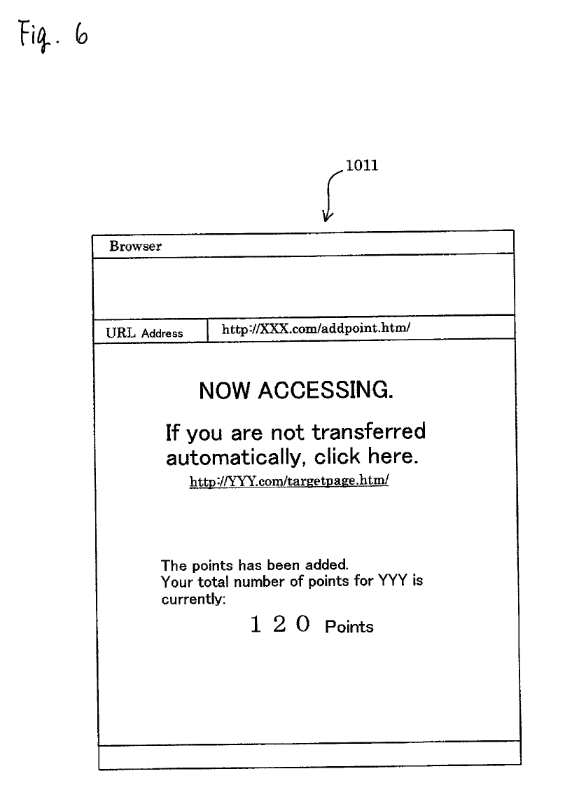

Further, the web server 1021 of the agent sends a webpage, for example as shown in FIG. 6. Referring to FIG. 6, on the web browser 1011 of the consumer, a message such as “On Login” is described to explain that the web page is transferred to the URL of the advertisement offerer, for example http://YYY.com/targetpage.htm/. At that time, a webpage is displayed, in which the text of the number of the obtained points for the advertisement offerer YYY, such as 120 points, is described (Procedure S6).

In an answer header at the time of sending this webpage, an instruction of writing the user ID as a cookie is included, and the web browser 101 of the consumer which received the answer header writes the user ID in the appointed file on the memory device 302 of the computer 101 of the agent.

As the concerned webpage is displayed on the web browser 1011 of the consumer, the consumer can confirm what number of the obtained points exists or how the number of the obtained points increased, regarding the advertisement offerer up to now.

On the webpage as shown in FIG. 6, a message explaining that the URL address will be changed to the URL address of the advertisement offerer in a few seconds is described, after that time is passed, the web browser 1011 of the consumer is connected with the web server 1031 of the advertisement offerer.

By the web server 1031 of the advertisement offerer which received the request from the web browser 1011 of the consumer via the web server 1021 of the agent, a webpage which uses picture information and music information for advertising goods and services is sent to the web browser 1011 of the consumer, and on which the webpage of the advertisement offerer is displayed.

By repeating the above processes for a certain consumer, the numbers of points for a plurality of advertisement offerers are accumulated separately to some extent. Then, the consumer can exchange the points for goods prepared in accordance with the number of the points.

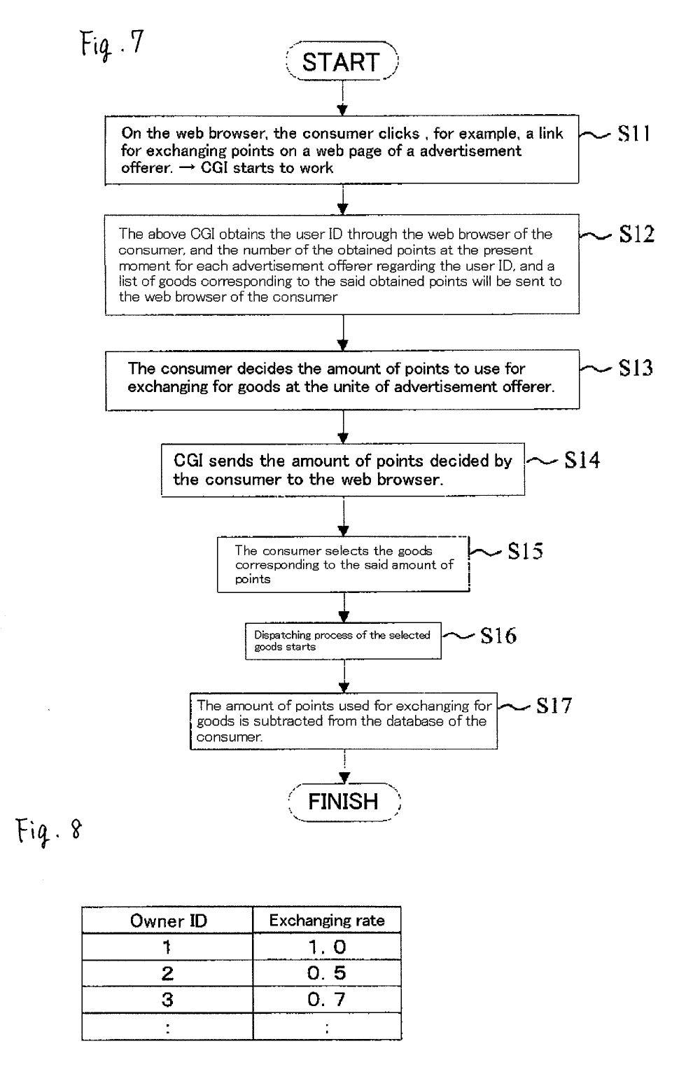

Hereinafter, referring to the flow chart shown in FIG. 7, a description is given of the procedure of exchanging points.

When a consumer want to know the number of the existing obtained points for each advertisement offerer at the present moment, moreover, when the consumer want to exchange points for goods, the consumer clicks, for example, a link for confirming/exchanging points on a webpage of a advertisement offerer, which the consumer is browsing at that time (Procedure S11). In this way, a CGI for confirming/exchanging points on the web server 1021 of the agent starts to work.

The CGI, which started to work, obtains the user ID of the consumer through the web browser 1011 of the consumer, and request the database server 1022 to obtain the number of the obtained points for each owner ID (advertisement offerer) corresponding to the user ID. The database server 1022 gets the number of the obtained points for each owner ID (advertisement offerer) regarding the user ID received from the CGI, out of the user point managing DB 1025 (FIG. 10), and delivers the above number of the obtained points to the CGI. The database server 1022 gets an exchange rate for each owner ID, out of the owner managing DB 1023, and deliver the above exchange rate to the CGI, as well. The CGI sends the number of the obtained points and the exchange rate which are received from the database server 1022 and a list of goods corresponding to the obtained points which is stored in the appointed memory device, to the web browser 1011 of the consumer, as one webpage (Procedure S12).

FIG. 11 shows one example of a webpage displayed on the web browser 1011 of the consumer. As shown in FIG. 11, in the left side of a flame of the webpage, the existing number of the obtained points for each advertisement offerer regarding the consumer is displayed. Moreover, the total of each summed points of advertisement offerers is displayed in the left side of a flame of the webpage. Further, in the side of the number of the points for each advertisement offerer, an exchange rate and a check box are displayed. Still further, in the right side of the flame of the webpage, goods, which are exchangable by points, are displayed with the required number of points.

The consumer refers the existing number of the obtained points displayed on the webpage. In the case where the consumer wants to exchange the points for goods, the consumer selects the advertisement offerers whose points are to be used for exchanging for goods by clicking the check box of that advertisement offerers (Procedure S13). In the example of FIG. 11, a site A and a site B are selected. In such condition, as “Button of summing the used points” is clicked, the sum of the points of the selected advertisement offerers are displayed (Procedure S14). The exchange rate is used in this calculation of summing points. In the example of FIG. 11, the points of site A is 300p, the points of site B is 400p, and the exchange rate of the site B is 0.5, therefore, the sum of the used points is 500p.

In the case where the consumer wants to exchange the summed points for goods, the consumer selects the goods which are exchangable by the summed points, from the list of the goods in the right side of the flame and clicks an exchange button (See FIG. 11) for the selected goods (Procedure S15). Then, for example, a CGI linked to the “exchange button” is made to start to work on the web server 1021 of the agent. This CGI instructs a sending process section of the selected goods to send the goods, for example by e-mail (Procedure S16), at the same time, instructs the database server 1022 to subtract the exchanged points from the user point managing server 1025 (Procedure S17).

As described above, the number of the obtained points of each consumer is managed for each advertisement offerer. When consumers exchange points for a value, the consumers can select points for service offerer. Moreover, the points of each advertisement offerer are summed up under an appointed exchange rate. Therefore, consumers can exchange points for goods for each advertisement offerer. This means that each advertisement offerer can separately offer their services using points provided by themselves. Still further, advertisement offerers who have already carried out their original point services also can utilize this point managing method, without changing the content of their services.

In the case where each advertisement offerer separately exchange points by using points provided by themselves, each advertisement offerer may separately make such a goods exchanging page as shown in FIG. 11 and utilize the information in the user point managing DB 1025 through the database server 1022 of the agent. In this case, it is necessary for a advertisement offerer to set up a certification means by which it is possible for consumers to browse and renew point information only about the advertisement offerer (the concerned owner ID's).

In an embodiments of the present invention it is assumed that consumers can select the points to be exchanged for goods for advertisement offerer. However, it is also possible for consumers to freely appoint points to be used for exchange for each advertisement offerer. For example, it may be possible to exchange 300p for goods, using 200p from 500p of the site A and 100p from 200p of the site B (In the case where both of the exchange rates are 1.0). This way of selecting points is very convenient for consumers because a waste of points can be avoid.

Still further, in an embodiment of the present invention, the description is given of the point managing method in one point managing organization. However, it is also possible to mutually refer and sum up points of a certain consumer and exchange the summed points for a value among a plurality of point managing organization.

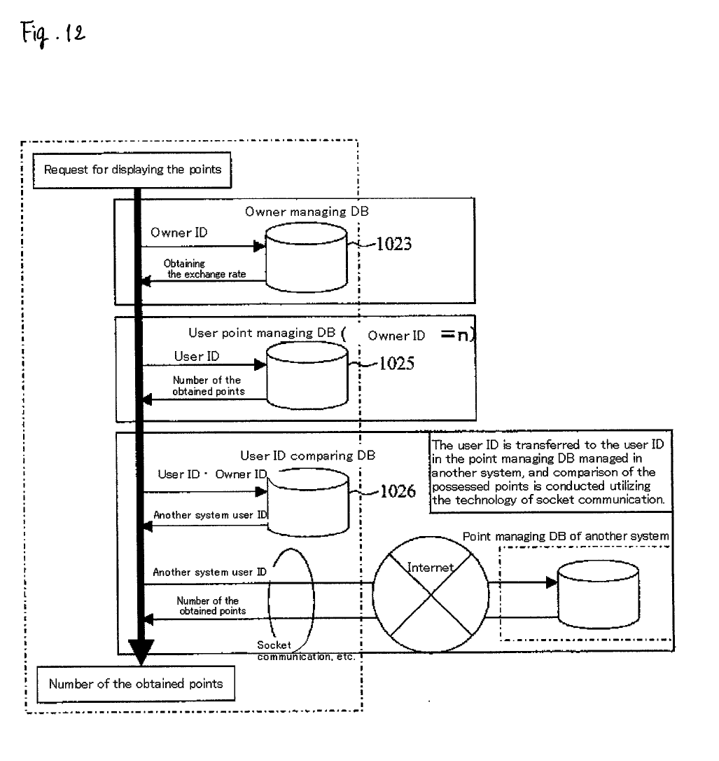

In such case, as shown in FIG. 12, it can be thought that in the computer group 102 of the agent, an user ID comparing DB 1026 is set up, wherein the correspondence relationship between the user IDs in the concerned point managing organization and in other point managing organizations regarding the same consumer is appointed. For example, on receipt of a request for displaying the obtained points from a consumer, the database server 1022 obtain an exchange rate of each owner ID from the owner managing DB 1023, the number of the obtained points for each owner ID from the user managing DB 1023 and the user ID in another organization corresponding to the user ID in the concerned point managing organization from the user ID comprising DB 1026.

And then, the database server 1022 obtains the number of the obtained points of the user by connecting with a point managing DB of another organization using the publicly known technique, such as socket communication. Furthermore, the database server 1022 displays the number of the obtained points of the user in another organization with the number of the obtained points of the user in the concerned point managing organization.

Still further, if a consumer request to exchange points, including points of other organizations, for a value, after a process of sending goods is started normally, a process of subtracting the used points of the consumer can be conducted, connecting with the point managing DB of other organizations using the publicly known technique, such as socket communication same as the above.

As described above, by newly setting up the user ID comparing DB 1026, wherein the relationship of correspondence of user IDs among a plurality of point managing organization, it is possible to refer points and exchange points for a value even among a plurality of organization like in one organization.

Furthermore, in the above examples, it is assumed that advertisement offerers offers advertisements for consumers on their webpage, and that the advertisement offerers provides appointed points to the consumers who browses their webpages. However, the kinds of services as an object for providing points are not limited to the above service. Many kind of services can be thought such as registration for sending mail magazine, using online shop, replying to questionnaires, requesting for sending information, members registration for services, etc.

Still further, as a corresponding value of the exchanged points, many kind of services can be thought such as discounting fees, complimentary services, besides the above mentioned goods.

As explained above, the present invention provides a point managing method using a computer for managing points, which are provided to consumers by each service offerer when the consumers use services offered by each service offerer. The points are exchangable for a fixed value. The point managing method includes the steps of storing the number of accumulated points of each service offerer in a point storing means for each consumer, and displaying the number of the accumulated points of a consumer for each service offerer as a list, which is stored in the point storing means. Each service offerer's identity is emphasized and service offerers' efforts to increase their sales can succeed. The point managing method according to the present invention further comprises the step of displaying an exchanging point input page on which the consumer can select service offerers whose points are to be exchanged for the value. By means of such composition, the consumer can select service offerers whose points are to be exchanged for a value depending on the consumer's preference. Still further, the point managing method according to the present invention further comprises the steps of summing up the accumulated points of each selected service offerer regarding the consumer under the appointed rate, after service offerers are selected as mentioned above, and in accordance with the summed points, a process of exchanging points for the value may be conducted, and subtracting points of each selected service offerers regarding the consumer, which were used for exchanging for the value, from the point storing means, using a computer.

By means of such a composition, consumers will buy goods and browse advertisements regarding service offerers whose exchange rates are high, whereby, the efforts of service offerers who keep their exchange rates high will succeed.

Furthermore, consumers may select a part of points provided by service offerers when the consumers select service offerers whose points are to be exchanged for the value. In this case, consumers can avoid a waste of the points, thus, this way of selecting points can increase consumers' convenience.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A point managing method, using a computer for managing points, said points being provided to consumers by each service offerer when the consumers use services offered by each service offerer, the points are exchangable for a fixed value, comprising the steps of:
storing the number of accumulated points of each service offerer in a point storing means for each consumer; and
displaying the number of the accumulated points of a consumer for each service offerer as a list, which is stored in the point storing means.

2. The point managing method according to claim 1 further comprising the step of:
displaying an exchanging point input page on which the consumer can select service offerers whose points are to be exchanged for the value.

3. The point managing method according to claim 2 further comprising the steps of:
after service offerers whose points are to be exchaged are selected, summing up the accumulated points of each selected service offerer for the consumer under an appointed rate, and in accordance with the summed points, exchanging points for value; and
subtracting points of each selected service offerers, for the consumer, which were used for exchanging for the value, from the point storing means.

4. The point managing method according to claim 1, wherein the consumers optionally select a part of points provided by each service offerer when the consumers select service offerers whose points are to be exchanged for the value.

5. The point managing method according to claim 2, wherein the consumers optionally select a part of points provided by each service offerer when the consumers select service offerers whose points are to be exchanged for the value.

6. The point managing method according to claim 3, wherein the consumers optionally select a part of points provided by each service offerer when the consumers select service offerers whose points are to be exchanged for the value.

7. A method for managing points earned by a consumer by using services offered by at least one service offerer, comprising:
storing points earned by said consumer in a point storing means;
said point storing means differentiating points earned by said consumer from each of said at least one service offerer, whereby, upon redemption, each of said at least one service offerer may accept only points earned by said consumer by using only their own service, or optionally, may accept combined points earned by said consumer from their own service and from said another service offerer.

8. The method for managing points according to claim 7, further comprising:
displaying the number of the accumulated points of said consumer for each of said at least one service offerer as a list, said list being stored in said point storing means.

9. The method for managing points according to claim 8, further comprising:
displaying an exchanging point input page on which said consumer selects from said at least one service offerer whose points are to be exchanged for a value.

10. The method for managing points according to claim 9, further compising:
after said at least one service offerer whose points are to be exchaged is selected, summing up the accumulated points of each selected service offerer for said consumer under an appointed rate, and, in accordance with the summed points, exchanging points for said value; and
subtracting points of each selected service offerer, for said consumer, which were used for exchanging for the value, from the point storing means.

11. The method for managing points according to claim 7, wherein said consumers optionally select a part of points provided by each of said at least one service offerer when said consumers select service offerers whose points are to be exchanged for the value.

12. The method for managing points according to claim 8, wherein said consumers optionally select a part of points provided by each of said at least one service offerer when said consumers select service offerers whose points are to be exchanged for the value.

13. The method for managing points according to claim 9, wherein said consumers optionally select a part of points provided by each of said at least one service offerer when said consumers select service offerers whose points are to be exchanged for the value.

14. The method for managing points according to claim 10, wherein said consumers optionally select a part of points provided by each of said at least one service offerer when said consumers select service offerers whose points are to be exchanged for the value.

15. A point managing system, comprising:
means for storing the number of accumulated points of each service offerer in a point storing means for each consumer; and
means for displaying the number of the accumulated points of a consumer for each service offerer as a list, which is stored in the point storing means.

16. The point managing system according to claim 15, further comprising:
means for displaying an exchanging point input page on which the consumer can select service offerers whose points are to be exchanged for the value.

17. The point managing system according to claim 16, further comprising:
means for exchanging points for value and subtracting points of each selected service offerers, for the consumer, which were used for exchanging for the value, from the point storing means.

18. The point managing system according to claim 15, further comprising:
means for selecting a part of points provided by each service offerer when the consumers select service offerers whose points are to be exchanged for the value.

19. The point managing system according to claim 16, further comprising:
means for selecting a part of points provided by each service offerer when the consumers select service offerers whose points are to be exchanged for the value.

20. The point managing system according to claim 17, further comprising:
means for selecting a part of points provided by each service offerer when the consumers select service offerers whose points are to be exchanged for the value.
